(19) United States
(12) Patent Application Publication
(10) Pub. No.: US 2005/0016333 A1
(43) Pub. Date: Jan. 27, 2005

(54) Power tool, adapter and method of operating the same

(75) Inventor: Gary Compton, Waterford, WI (US)

Correspondence Address: MICHAEL BEST & FRIEDRICH, LLP, 100 E WISCONSIN AVENUE, MILWAUKEE, WI, 53202, US

(73) Assignee: Milwaukee Electric Tool Corporation, Brookfield, WI (US)

(21) Appl. No.: 10/876,165

(22) Filed: Jun. 24, 2004

Related U.S. Application Data
(60) Provisional application No. 60/483,458, filed on Jun. 27, 2003.

(51) Int. Cl. B25B 23/16

(52) U.S. Cl. 81/177.85

(57) ABSTRACT

An adapter for use with a power tool to remove a stuck tool element from a workpiece. The power tool includes a housing, a motor supported by the housing and a drive member drivingly connectable to the motor and being rotatable with respect to the housing. The adapter includes an elongated drive shank having a first end and a second end and defining an axis extending therebetween, the first end being drivingly engageable with the drive member of the power tool, the second end defining an aperture extending along the axis and being configured to matingly receive the tool element. The drive shank is rotatable about the axis and is configured to transfer rotational motion from the drive member to the tool element to remove the stuck tool element from the workpiece.

### RELATED APPLICATIONS

The present application claims the benefit of prior-filed, co-pending provisional patent application Ser. No. 60/483,458, filed Jun. 27, 2003, the contents of which is hereby incorporated by reference.

### FIELD OF THE INVENTION

The present invention relates to power tools and, more particularly, to a power tool and an adapter for a power tool.

### SUMMARY OF THE INVENTION

A power tool, such as a drill, a rotary hammer, etc., generally includes a housing, a motor supported by the housing and connectable to a power source, a spindle driven by the motor and adapted to support a tool element to work on a workpiece. During operation, such as, for example, drilling and/or hammering operations, the tool element may become bound or stuck in the workpiece.

In some constructions, the power tool, such as, for example, the rotary hammer, is not operable in a reverse direction and, therefore, cannot remove or loosen a stuck tool element from a workpiece. Also, some power tools which are operable in a reverse direction may not be able to generate sufficient torque in the reverse direction and, therefore, may be unable and/or may have limited ability to remove or loosen a stuck tool element from a workpiece.

If the power tool cannot remove the stuck tool element, the stuck tool element must typically be removed from a workpiece by hand (i.e., without the assistance of a power tool) with a pipe wrench. Such a removal process is very difficult and time consuming. Also, the tool element may be damaged or broken during extraction. If the tool element cannot be removed by hand, it must be cut off at the workpiece surface, or it is left stuck in the workpiece, typically at great cost to the operator.

For example, rotary hammer bits are typically very expensive and cannot be removed by the rotary hammer (which cannot operate in a reverse direction). If such an expensive bit is not removed by hand, it must be cut off at the workpiece surface and be replaced at great cost to the operator. The remaining portion of the abandoned rotary hammer bit may also provide an obstruction if it is left in the workpiece.

The present invention provides, among other things, an adapter for a power tool, such as, for example, an impact wrench, which substantially alleviates one or more independent problems with the above-described power tools. In some constructions and in some aspects, the present invention provides a power tool, such as an impact wrench, and an adapter that are operable to drive a tool element, such as a rotary hammer bit. Also, in some aspects and in some constructions, the power tool, such as an impact wrench, and the adapter are operable to remove a stuck tool element, such as a rotary hammer bit, from a workpiece.

More particularly, in some constructions and in some aspects, the present invention may provide a power tool, such as an impact wrench, generally including a housing, a motor and a drive member supported by the housing, and an adapter selectively supportable by the drive element and engageable with the tool element, the motor being operable to drive the drive member and the tool element for working on a workpiece. The adapter may generally include a locking arrangement for lockingly engaging a tool element.

Also, in some aspects and in some constructions, the present invention provides a power tool, such as an impact wrench, generally including a housing, a motor supported by the housing and connectable to a power source, a drive assembly drivingly connectable to the motor and including a ram member having a ram lug and an anvil member rotatably supported by the tool housing and having an anvil lug engageable with the ram lug to drive the anvil member, and an adapter drivingly engageable with the drive assembly, the adapter being drivingly connectable to a tool element to rotatably drive the tool element.

In addition, in some aspects and in some constructions, the present invention may provide an adapter for a power tool, such as an impact wrench. The adapter generally includes an elongated drive shank having a first end engageable with at least a portion of the power tool, and a second end engageable with a tool element.

The adapter may generally include a locking arrangement for movement between a locking condition, in which the locking arrangement is lockingly engageable with the tool element, and an unlocking condition, in which the tool element is removable from the adapter. The locking arrangement may generally include a sleeve supported on the drive shank and locking elements, the locking elements being engageable with the tool element and the sleeve. Also, the locking arrangement may generally include a biasing member, the biasing member biasing the locking arrangement toward the locking condition.

Further, in some aspects and in some constructions, the present invention may provide a method of using a power tool, such as an impact wrench, to drive a tool element, such as a rotary hammer bit. Also, in some aspects and in some constructions, the present invention may provide a method of using a power tool, such as an impact wrench, and an adapter to remove a stuck tool element, such as a rotary hammer bit, from a workpiece.

The method may generally include the acts of connecting the adapter to the power tool, connecting the adapter to the tool element, and rotating the adapter and the tool element with the power tool. Also, the method may generally include the act of locking the tool element in the adapter with a locking arrangement. In addition, the act of rotating may generally include rotating the adapter in a reverse direction.

Independent features and independent advantages of the present invention will become apparent to those skilled in the art upon review of the following detailed description and drawings.

### BRIEF DESCRIPTION OF THE DRAWINGS

FIG. 1 is a side view of a power tool, such as, for example an impact wrench, and an adapter.

FIG. 2 is a side view of the power tool shown in FIG. 1.

FIG. 3 is a partial cross-sectional side view of the power tool shown in FIG. 1.

FIG. 3A is a partial cross-sectional side view of a second power tool, such as, for example, a rotary hammer.

FIG. 4 is a perspective view of the adapter shown in FIG. 1.

FIG. 5 is an enlarged cross-sectional view of the adapter shown in FIG. 1.

FIG. 6 is a side view of a power tool, such as, for example an impact wrench, and an alternative construction of an adapter.

FIG. 7 is a perspective view the adapter shown in FIG. 6.

FIG. 8 is an enlarged cross-sectional view of the adapter shown in FIG. 6.

FIG. 9 is a perspective view of an alternative construction of an adapter.

FIG. 10 is an enlarged cross-sectional view of the adapter shown in FIG. 9.

Before at least one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

A power tool, such as, for example, an impact wrench 10, and an adapter 14 embodying aspects of the invention are illustrated in the Figures. It should be understood that, for some aspects of the invention and in some constructions (not shown), the power tool may be another type of power tool, such as, for example, a hammer, a rotary hammer, a circular saw, a drill, etc.

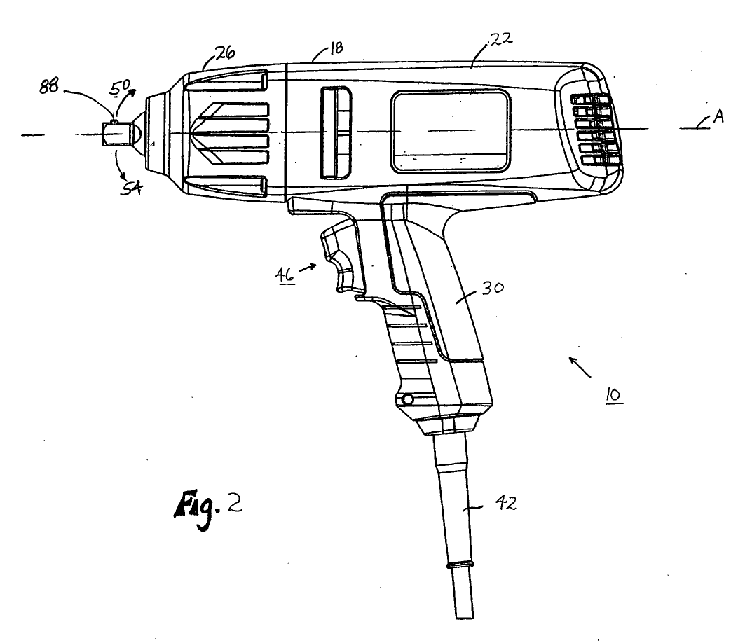

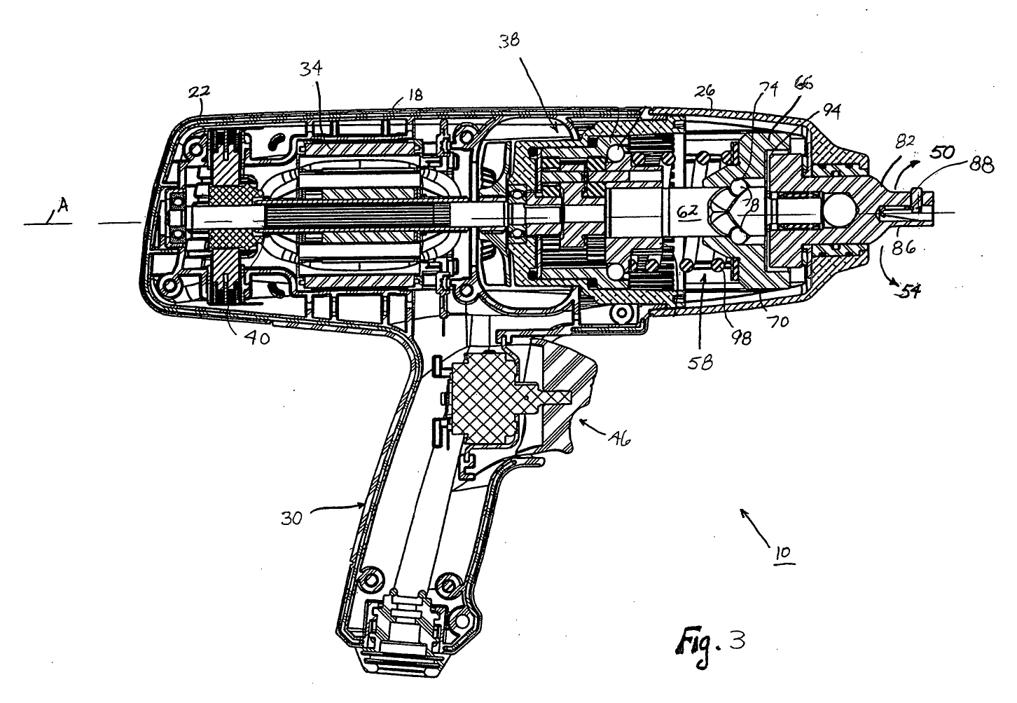

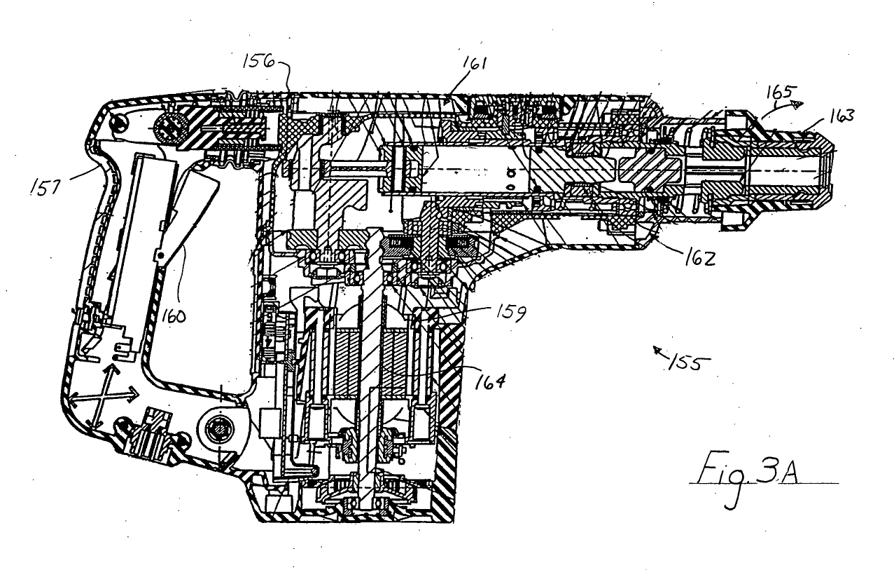

As shown in FIGS. 2 and 3, the impact wrench 10 generally includes a body 18 having a motor housing 22, a gear case 26, and a handle portion 30. The body 18 houses a motor 34 and a drive mechanism 38 drivingly connected to the motor 34. The motor 34 includes a motor shaft 40 and is connectable to a power source. An on/off switch, such as a trigger assembly 46, is supported on the handle portion 30 and is operable to electrically connect the motor 34 to the power source.

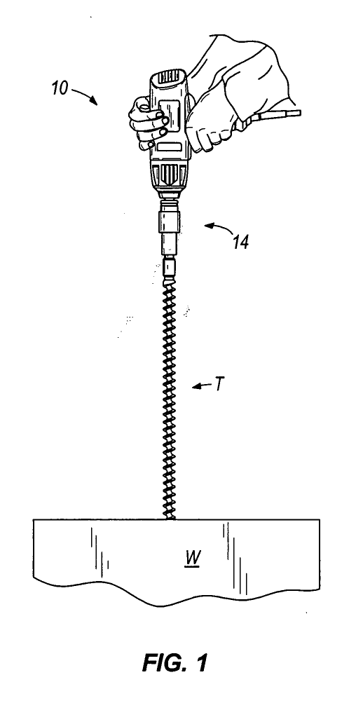

In the illustrated constructions (see FIGS. 1-3), the power source is an electrical power source, such as an AC power source, and the impact wrench 10 includes a power cord 42 to connect the motor 34 to the AC power source. In other constructions (not shown), the power source may be a battery power source, and the impact wrench 10 may include a battery which is removably supported on the handle portion 30. In yet another construction (not shown), the power source may be another type of power source, such as, for example, a pneumatic or fluid power source.

The motor 34 and the drive mechanism 38 are operable to selectively drive the adapter 14 generally about the axis A in a first or forward direction (for example, in a clockwise direction as represented by arrow 50 in FIGS. 2 and 3) or in a second or reverse direction (for example, in a counterclockwise direction as represented by arrow 54 in FIGS. 2 and 3). The adapter 14 can be removed, and the motor 34 and the drive mechanism 38 can be used to selectively drive a tool element, such as a socket member (not shown), in the forward direction 50 to work on or fasten a nut or bolt (not shown) or in the reverse direction 54 to remove the nut or bolt from a workpiece W. In still other constructions, another type of tool element (not shown) may be driven.

As shown in FIG. 3, the impact wrench 10 also includes a drive assembly 58 drivingly connected to the drive mechanism 38. In the illustrated construction, the drive assembly 58 includes a cam shaft 62 connected to the drive mechanism 38 for rotation about the axis A. The drive assembly 58 also includes a ram member 66 drivingly connected to the cam shaft 62 for rotation with the cam shaft 62. The ram member 66 includes a generally cylindrical body 70 and forwardly projecting impact or ram lugs (not shown) spaced apart about the circumference of the body 70. A raised side wail (not shown) extends about the periphery of the body 70 and connects the ram lugs. The ram member 66 also defines grooves 74 in which cam balls 78 are supported to drivingly connect the cam shaft 62 and the ram member 66 and to allow axial movement of the ram member 66 relative to the cam shaft 62.

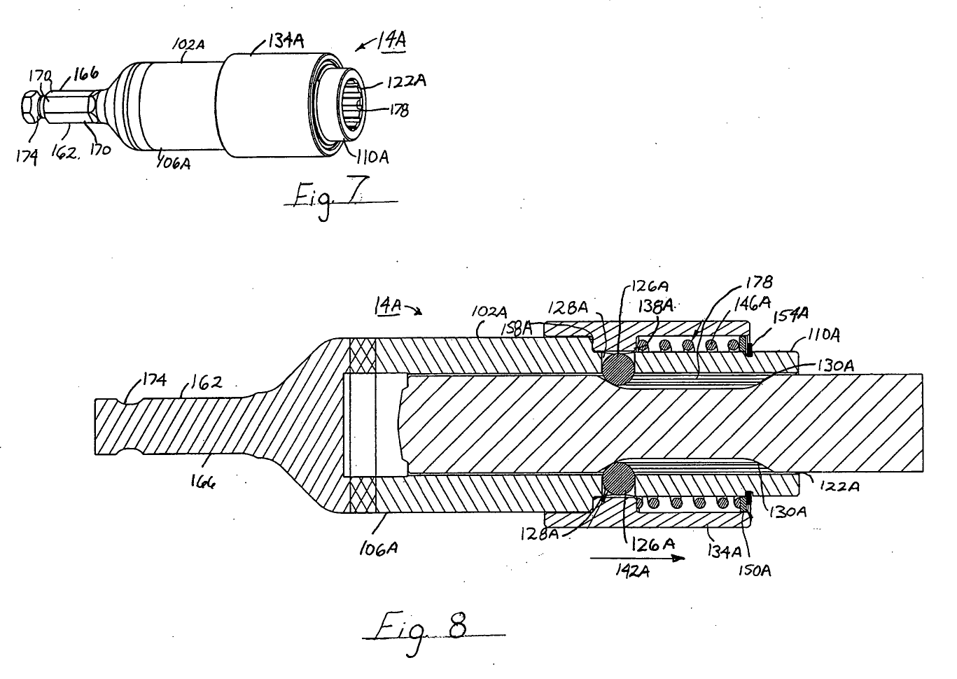

The drive assembly 58 also includes an anvil member 82. The anvil member 82 includes an axially-extending drive member 86, which is connectable to a tool element or to the adapter 14, and a radially-extending impact or anvil lug 94. In some aspects and in the illustrated construction, the drive member 86 includes a square drive (e.g., ¾ inch, ½ inch or ¼ inch) for engaging conventional tool elements having square-shaped couplers and for engaging the adapter 14. In other aspects and in other constructions, the drive member 86 can have other configurations (not shown) including a hex drive, a D-shaped drive, etc. for engaging differently shaped tool elements and, as described below and as illustrated in FIGS. 7 and 8, for engaging other adapters 14A.

In the illustrated construction, the drive member 86 includes a retaining member 88, such as a ball or pin. The retaining member 88 is biased outwardly from the drive member 82 and is engageable in a corresponding recess in a tool element to securely connect the drive member 82 and the tool element. Also, as described below, the retaining member 88 is engageable in channels 118 in the adapter 14 to securely connect the drive member 82 and the adapter 14. In other aspects and in other constructions (not shown), the drive member 86 defines an aperture configured to matingly receive a correspondingly shaped ball or pin. In this manner, tool elements (not shown) having a locking member, such as, an outwardly biased ball or pin, can be connected to the drive member 86 by lockingly engaging the locking member in the aperture.

Each end of the anvil lug 94 provides an impact surface and is engageable with one of the ram lugs to rotatably drive the anvil member 82 upon rotation of the ram member 66. The drive assembly 58 also includes an elastic member 98, such as a spring, to bias the ram member 66 forwardly into engagement with the anvil member 82.

Components of the impact wrench 10, such as, for example, the body 18, the motor housing 22, gear case 26, handle portion 30, and drive assembly 58 are similar to those disclosed in co-pending, jointly-owned U.S. Pat. No. 6,733,414, issued on May 11, 2004, which is hereby incorporated by reference.

As shown in FIGS. 4 and 5, the adapter 14 includes an elongated drive shank 102 having a first or rearward end 106, which is configured to matingly engage the drive member 86 of the impact wrench 10, and a second or forward end 110, which is configured to receive a tool element T. More particularly, inner walls of the rearward end 106 define a first or rearward aperture 114 that is adapted to matingly receive the drive member 86. In the illustrated construction and as described above, the drive member 86 has a substantially square shape, and the first aperture 114 has a complementary shape to matingly receive the drive member 86.

In other aspects and in other constructions (not shown), the aperture 114 may have a different shape (e.g., D-shaped, pentagonally shaped, hexagonally shaped, etc.) to engage drive members having that same shape. In still other aspects and in other constructions (not shown), the aperture 114 may include splines for engaging a tool element having a splined shaft.

Channels 118 extend radially through at least a portion of the rearward end 106 of the drive shank 102 and communicate with the rearward aperture 114. In some aspects and in the illustrated construction, when the adapter 14 is connected to the impact wrench 10, the retaining member 88 engages one or more of the channels 118 to lockingly connect the adapter 14 and the impact wrench 10. In other aspects and in other constructions (not shown), the adapter 14 includes locking elements, such as balls or pins, that are engageable in corresponding apertures in the drive member 86 to matingly connect the adapter 14 to the drive member 86.

The forward end 110 of the drive shank 102 defines a second or forward aperture 122 configured to receive a tool element T. In some aspects and in the illustrated construction, the forward aperture 122 is configured to receive a rotary hammer bit with an SDS shank. In other aspects and in other constructions (not shown), the forward aperture 122 can have another configuration to receive another conventional tool element, such as, for example, a tool element having a splined shaft, a K-hex shaped shaft, a hexagonal shaft, etc. As shown in FIG. 5, locking elements 126, such as balls, extend radially through bores or channels 128 in walls of the drive shank 102 into the forward aperture 122 and are engageable in elongated recesses 130 that extend along a portion of the tool element T.

The adapter 14 also includes a locking collar or sleeve 134 supported on the drive shank 102 between the rearward and forward ends 106, 110 for sliding motion between a first or locking position (shown in FIG. 5) and a second or unlocking position (not shown). A protrusion 138 extends circumferentially around and radially inward from an interior surface of the sleeve 134. As shown in FIG. 4, when the sleeve 134 is in the locking position, the protrusion 138 is aligned with the channels 128 and the locking elements 126 to bias the locking elements 126 at least partially into the forward aperture 122 to lockingly engage the tool element T. In some aspects and in the illustrated construction, when the sleeve 134 is in the locking position, the protrusion 138 biases the locking elements 126 into the elongated recess 130 in the tool element T, securing the tool element T to the adapter 14.

To insert a tool element T into the forward aperture 122, the operator moves the sleeve 134 forwardly toward the unlocking position and inserts the tool element T into the first aperture 122. Once the tool element T is fully inserted into the forward aperture 122, the operator returns the sleeve 134 to the locking position, and the protrusion 138 forces the locking elements 126 into locking engagement with the elongated recesses 130 in the tool element T.

Similarly, to remove the tool element T from the adapter 14, an operator slides the sleeve 134 forwardly in a direction generally parallel to the axis A (i.e., in the direction illustrated by arrow 142 in FIG. 5) toward the unlocking position. As the sleeve 134 is moved toward the unlocking position, the protrusion 138 is able to move out of engagement with the locking elements 126. An operator can then remove the tool element T from the adapter 14 by pulling the tool element T out of the forward aperture 122. As the tool element T is pulled forwardly out of the forward aperture 122, the locking elements 126 are moved radially out of the elongated recesses 130 and into the channels 128.

A biasing member 146, such as a spring, extends circumferentially around a portion of the drive shank 102. A first end of the biasing member 146 engages the protrusion 138, and a second end of the biasing member 146 engages a support washer 150. The support washer 150 is held in position on the drive shaft 102 by a fastener 154, such as, for example, a retaining ring, a snap ring, a key, a pin, etc. The biasing member 146 biases the sleeve 134 toward the locking position. Rearward motion (i.e., motion toward the first end 106 of the adapter 14) of the sleeve 134 is limited by a shoulder 158 of the drive shank 102 and forward motion (i.e., toward the second end 110 of the adapter 14) is limited by the support washer 150 and the fastener 154.

The impact wrench 10 and the adapter 14 are operable to remove tool elements T that have become stuck or bound in workpieces W during drilling or hammering operations. For example, in some applications and as shown in FIG. 2A, a power tool, such as a rotary hammer 155, is used to drill holes in workpieces W, such as concrete, asphalt, wood, etc., and the tool element T, such as a rotary hammer bit, may become stuck or bound in the workpiece W. In some aspects and in the illustrated construction, the hammer 155 includes a housing or body 156, an operator's grip or handle 157, an electric motor 159 connectable to a power source (not shown) by an on/off switch 160, a rotary drive system 161, and a reciprocating drive system 162. The hammer 155 also includes a tool holder or chuck 163 for supporting the tool element T. In general, the motor 159 includes a motor shaft 164, which drives at least a portion of the rotary drive system 161.

In such applications, the operator is unable to dislodge the stuck tool element T from the workpiece W with the rotary hammer 155 because the rotary hammer 155 cannot operate in a reverse driving mode and is, therefore, unable to back the stuck tool element T out of the workpiece W. Specifically, in some aspects and in the illustrated construction, the motor 159 and the rotary drive system 161 are operable to rotate the chuck 163 and a tool element T supported in the chuck 163 in only a forward direction (represented by arrow 165). In other instances (not shown), the power tool may include a slip clutch or another similar torque limiting apparatus that limits torque transfer from the power tool to the stuck tool element T, and, therefore, such a power tool may not be able to apply sufficient torque to remove the stuck tool element T.

When the tool element T is stuck in a workpiece W, the operator disconnects the rotary hammer 155 from the stuck tool element T and connects the adapter 14 to the impact wrench 10, as described above. The operator then aligns the adapter 14 with the tool element T and moves the sleeve 134 toward the unlocking position to receive the tool element T in the forward aperture 122, as described above. Once the tool element T is positioned in the forward aperture 122, the operator releases the sleeve 134, causing the protrusion 138 to move the locking elements 126 into locking engagement with the tool element T.

After the adapter 14 is secured to the impact wrench 10 and the tool element T, the operator depresses the trigger 46 to connect the motor 34 to the power source. The motor 34 drives the drive mechanism 38 in the reverse drive direction 54. The drive mechanism 38 rotates the cam shaft 62 and the ram member 66. As the ram member 66 rotates, a ram lug engages each end of the anvil lug 94 to provide an impact and to rotatably drive the anvil member 82 and the tool element T in the reverse drive direction 54. After the impact, the ram member 66 moves rearwardly so that the ram lugs disengage from the anvil lug 94. As the ram member 66 moves rearwardly, the cam balls 78 move rearwardly in the cam grooves 74. The spring 98 stores some of the rearward energy of the ram member 66 to provide a return mechanism for the ram member 66. After the ram lugs disengage from the anvil lug 94, the ram member 66 continues to rotate and moves forwardly (as the spring 98 releases its stored energy) until the ram lugs engage the opposite ends of the anvil lug 94 to cause another impact.

As the ram lugs impact the anvil lug 94, rotational motion is transferred to the anvil member 82 and from the drive member 86 to the adapter 14. Additionally, as the ram lug impacts the anvil member 82, the ram member 66 hammers or impacts the anvil member 82 in the reverse drive direction. The rotational motion is transferred from the adapter 14 to the tool element T to loosen the tool element T from and/or back the tool element T out of the workpiece W.

Once the tool element T is unstuck from the workpiece W, the tool element T is removed from the adapter 14, as described above, and is re-connected to the rotary hammer 155 to re-commence drilling or hammering. Alternatively, the tool element T can remain connected to the adapter 14 and the adapter 14 and the impact wrench 10 can be used with the tool element T to continue working on the workpiece W (by driving in the forward direction with rotary impacts).

Because of the ability of the impact wrench 10 to operate in the reverse drive mode and to provide rotary impacts through the adapter 14 to the tool element T, the impact wrench 10 and adapter 14 are able to remove the stuck tool element T from the workpiece W. The impact wrench 10 and the adapter 14 are operable to drive a tool element T. In some aspects and in some constructions, the impact wrench 10 and the adapter 14 are operable to drive a tool element T into a workpiece W (see FIG. 1) or, alternately, to remove a tool element T from the workpiece W. The ability of the impact wrench 10 to provide rotary impacts in the forward drive direction may also be useful during drilling operations or to remove obstructions.

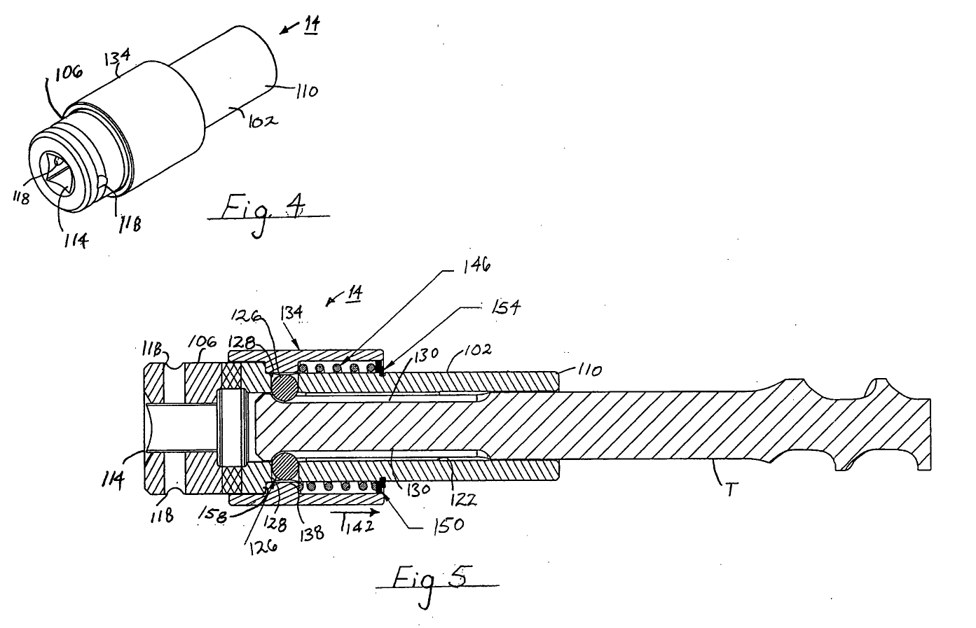

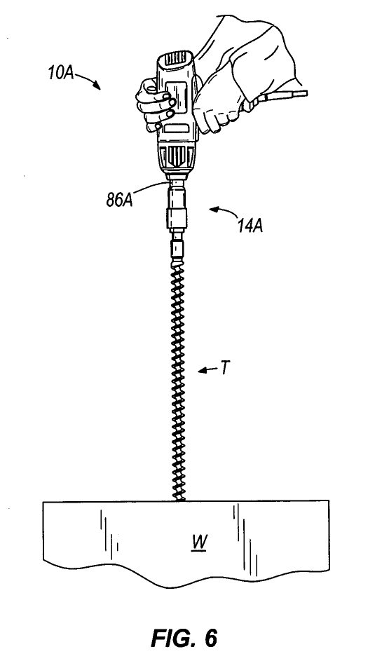

An alternative construction of a power tool, such as an impact wrench 10A, and an adapter 14A is illustrated in FIGS. 6-8. In the alternate construction, similar components are identified by the same reference number A.

In the construction shown in FIGS. 6-8, the axially-extending drive member 86A defines a forward aperture (not shown), which is configured to matingly receive a tool element T, such as a bit, or alternately, to matingly receive at least a portion of the adapter 14A.

As shown in FIGS. 7 and 8, the adapter 14A includes an elongated drive shank 102A having a first or rearward end 106A and a second or forward end 110A. A drive shaft 162 is connected to and extends rearwardly from the rearward end 106A of the drive shank 102A. In some aspects and in the illustrated construction, the drive shaft 162 includes an elongated body 166 having a number of sides 170 and defining a circumferential channel 174. The drive shaft 162 is configured to be matingly received in the forward aperture of the drive member 86A. In other aspects and in other constructions (not shown), the drive shaft 162 can have other shapes and configurations corresponding to differently configured drive members 86A. Also, in some aspects and in some constructions, the drive member 86A can include retaining members (not shown) that are engageable with the circumferential channel 174 to lockingly connect the adapter 14 and the impact wrench 10A.

The forward end 110A of the drive shank 102A defines a forward aperture 122A configured to receive a tool element T. In some aspects and in the illustrated construction, the forward aperture 122A is configured to receive a rotary hammer bit with a splined shank. Additionally, as shown in FIGS. 7 and 8, splines 178 extend radially inwardly from inner walls of the drive shank 102A into the forward aperture 122A to matingly engage corresponding splines of the tool element T.

In other aspects and in other constructions (not shown), the forward aperture 122A can have other configurations to receive another conventional tool element, such as, for example, a tool element having a K-hex shaft, hexagonal shaft, etc. As shown in FIG. 8, locking elements 126A, such as balls or rollers, extend radially through channels 128A in walls of the drive shank 102A into the forward aperture 122A and are engageable in elongated recesses 130A that extend along a portion of the tool element T.

The adapter 14A also includes a locking collar or sleeve 134A supported on the drive shank 102A between the rearward and forward ends 106A, 110A for sliding motion between a first or locking position (shown in FIGS. 7 and 8) and a second or unlocking position (not shown). A protrusion 138A extends circumferentially around and radially inward from an inner surface of the sleeve 134A. As shown in FIG. 8, when the sleeve 134A is in the locking-position, the protrusion 138A is aligned with the channels 128A and the locking elements 126A to bias the locking elements 126A at least partially into the forward aperture 122A to lockingly engage the tool element T. In some aspects and in the illustrated construction, when the sleeve 134A is in the locking position, the protrusion 138A biases the locking elements 126A into the elongated recesses 130A in the tool element T, securing the tool element T in the adapter 14A.

A biasing member 146A, such as a spring, extends circumferentially around a portion of the drive shank 102A and is held in position on the drive shank 102 between a support washer 150A and a fastener 154A and a shoulder 158A of the drive shank 102A. The biasing member 146A biases the sleeve 134A toward the locking position.

To insert a tool element T into the adapter 14A, the operator moves the sleeve 134A forwardly toward the unlocking position, aligns the splines of the tool element T with corresponding splines 178 of the drive shank 102A and inserts the tool element T into the first aperture 122A. Once the tool element T is fully inserted into the forward aperture 122A, the operator returns the sleeve 134A to the locking position, and the protrusion 138A forces the locking elements 126A into locking engagement with the elongated recesses 130A in the tool element T.

Similarly, to remove the tool element T from the adapter 14A, an operator slides the sleeve 134A forwardly in a direction generally parallel to the axis A (i.e., in the direction illustrated by arrow 142A in FIG. 5) toward the unlocking position. As the sleeve 134A is moved toward the unlocking position, the protrusion 138A is able to move out of engagement with the locking elements 126A. An operator can then remove the tool element T from the adapter 14A by pulling the tool element T out of the forward aperture 122A. As the tool element T is pulled forwardly out of the forward aperture 122A, the locking elements 126A are moved radially out of the elongated recesses 130A and into the channels 128A.

When a tool element T becomes stuck or bound in a workpiece W during hammering or drilling operations, the operator disconnects the tool element T from the power tool that was being used to drive the tool element T. The operator then connects the adapter 14A to the impact wrench 10A, as described above. The operator then aligns the adapter 14A with the tool element T and moves the sleeve 134A toward the unlocking position to receive the tool element T in the forward aperture 122A, as described above. Once the tool element T is positioned in the forward aperture 122A, the operator releases the sleeve 134A, causing the protrusion 138A to move the locking elements 126A into locking engagement with the tool element T.

After the adapter 14A is secured to the impact wrench 10A and the tool element T, the operator depresses the trigger 46A to connect the motor 34A to the power source. The motor 34A drives the drive mechanism 38A in the reverse drive direction 54A. The drive mechanism 38A and the drive assembly 58A transfer rotational motion to the anvil member 82A and from the drive member 86A to the adapter 14A. Additionally, as the ram lug impacts the anvil member 82A, the ram member 66A hammers or impacts the anvil member 82A in the reverse drive direction. The rotational motion is transferred from the adapter 14A to the tool element T to loosen the tool element T from and/or back the tool element T out of the workpiece W.

Once the tool element T is unstuck from the workpiece W, the tool element T is removed from the adapter 14A, as described above, and is re-connected to the power tool to re-commence drilling or hammering. Alternatively, the tool element T can remain connected to the adapter 14A and the adapter 14A and the impact wrench 10A can be used with the tool element T to continue working on the workpiece W (by driving in the forward direction with rotary impacts).

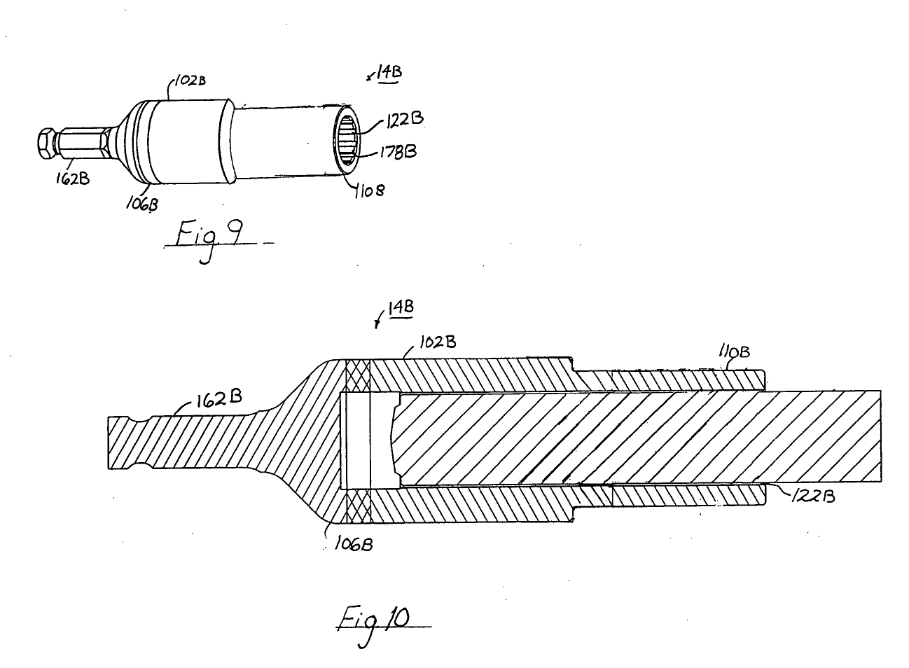

Another alternative construction of an adapter 14B is illustrated in FIGS. 9 and 10. In the alternate construction, similar components are identified by the same reference number B.

As shown in FIGS. 9 and 10, the adapter 14B includes an elongated drive shank 102B having a first or rearward end 106B and a second or forward end 110B. A drive shaft 162B is connected to and extends rearwardly from the rearward end 106B of the drive shank 102B.

The forward end 110B of the drive shank 102B defines a forward aperture 122B configured to receive a tool element T. In some aspects and in the illustrated construction, the forward aperture 122B is configured to receive a rotary hammer bit with a splined shank. Additionally, as shown in FIGS. 9 and 10, splines 178B extend radially inwardly from inner walls of the drive shank 102B into the forward aperture 122B to matingly engage corresponding splines (not shown) of the tool element T.

In some aspects and in the construction illustrated in FIGS. 9 and 10, the adapter 14B does not include a locking assembly. Rather, in the illustrated construction, the splines 178B matingly engage a tool element T and transfer rotational motion from a power tool 10 to the tool element T. The operator maintains a tool element T in the forward aperture 122B by applying a downward force (i.e., toward the workpiece W) to the adapter 14B and the tool element T. When the operator removes the downward force from the adapter 14B, the operator can slide the tool element T out of the forward aperture 122B.

In other aspects and in other constructions (not shown), the adapter 14B can include a locking assembly. For example, in some aspects and in some constructions (not shown), the adapter 14B can include locking elements, such as balls, extending radially through channels in walls of the drive shank 102B into the forward aperture 122B and a locking collar or sleeve supported on the drive shank 102B between the rearward and forward ends 106B, 110B for sliding motion between a locking position and an unlocking position.

In other aspects and in other constructions (not shown) the adapter 14B can include other locking elements. For example, in some aspects and in some constructions (not shown), a magnet is located in the forward aperture 122B to magnetically connect the adapter 14B and a metallic tool element T. Alternatively or in addition, in other aspects and in other constructions (not shown), the drive shank 102B supports a conventional chuck assembly, which is operable to connect tool elements T to the adapter 14B.

One or more of the above-identified and other independent features or independent advantages of the invention are set forth in the following claims:

1. An adapter for use with a power tool to remove a stuck tool element from a workpiece, the power tool having a housing, a motor supported by the housing and a drive member drivingly connectable to the motor and being rotatable with respect to the housing, the adapter comprising:
an elongated drive shank having a first end and a second end and defining an axis extending therebetween, the first end being drivingly engageable with the drive member of the power tool, the second end defining an aperture extending along the axis and being configured to matingly receive the tool element;
wherein the drive shank is rotatable about the axis and is configured to transfer rotational motion from the drive member to the tool element to remove the stuck tool element from the workpiece.

2. The adapter of claim 1, wherein the adapter includes a locking arrangement for securing the tool element in the aperture of the second end.

3. The adapter of claim 2, wherein the tool element defines a locking recess, wherein the second end of the adapter defines a radially extending channel communicating with the aperture, and wherein the locking arrangement includes a locking element moveable along the channel into the locking recess for securing the tool element in the second end of the drive shank.

4. The adapter of claim 3, wherein the locking arrangement includes a collar supported on the drive shank for axial movement along the drive shank between a locking position, in which the collar contacts the locking element and biases the locking element radially inwardly through the channel into the aperture, and an unlocking position, in which the collar is moved out of engagement with the locking element.

5. The adapter of claim 4, wherein the collar includes a radially extending protrusion, and wherein when the locking arrangement is in the locking position, the protrusion is radially aligned with the channel, and wherein, when the locking arrangement is in the unlocking position, the protrusion is radially misaligned with the channel.

6. The adapter of claim 4, wherein the adapter includes a biasing member engaging the collar and biasing the collar toward the locking position.

7. The adapter of claim 1, wherein the stuck tool element is a bit for use with a rotary hammer, and wherein the power tool is an impact wrench.

8. The adapter of claim 1, wherein the power tool is an impact wrench, and wherein the rotational motion includes rotational impacts.

9. The adapter of claim 1, wherein the tool element includes radially outwardly extending splines, and wherein complimentary splines extend radially inwardly from the second end of the drive shank into the aperture for drivingly engaging the radially outwardly extending splines of the tool element.

10. The adapter of claim 1, wherein the first end of the adapter defines a rearward aperture, the drive member being matingly engageable in the rearward aperture to drivingly connect the power tool to the adapter.

11. The adapter of claim 10, wherein the drive member has a substantially square cross-sectional shape, and wherein the rearward aperture in the first end of the drive shank has a complimentary square cross-sectional shape for matingly receiving the drive member.

12. The adapter of claim 10, wherein the drive member includes at least one substantially flat side, and wherein the first end of the drive shank includes at least one substantially flat side partially defining the rearward aperture, the at least one substantially flat side of the drive member being engageable with the at least one substantially flat side of the rearward aperture to drivingly connect the drive member to the adapter.

13. The adapter of claim 10, wherein one of the first end of the adapter and the drive member of the power tool defines a radially extending channel, and wherein an other of the first end of the adapter and the drive member of the power tool includes a radially extending retaining member engageable in the channel to secure the drive member in the rearward aperture of the adapter.

14. The adapter of claim 1, wherein the drive member of the power tool includes a chuck, and wherein the first end of the drive shank includes an axially extending drive shaft engageable in the chuck.

15. An adapter for use with a first power tool to remove a stuck tool element of a second power tool from a workpiece, the first power tool having a housing, a motor supported by the housing and a drive member drivingly connectable to the motor and being rotatable with respect to the housing, the adapter comprising:
an elongated drive shank having a first end and a second end and defining an axis extending therebetween, the first end being drivingly engageable with the drive member of the first power tool, the second end being matingly engageable with the tool element, the drive shank being rotatable about the axis to transfer rotational motion from the drive member of the first power tool to the stuck tool element to remove the stuck tool element from the workpiece; and
a locking arrangement for securing the tool element to the second end of the drive shank.

16. The adapter of claim 15, wherein the second end of the drive shank defines an aperture extending along the axis and being configured to matingly receive the tool element.

17. The adapter of claim 16, wherein the tool element defines a locking recess, wherein the second end of the adapter defines a radially extending channel communicating with the aperture, and wherein the locking arrangement includes a locking element moveable along the channel into the locking recess for securing the tool element in the second end of the drive shank.

18. The adapter of claim 17, wherein the locking arrangement includes a collar supported on the drive shank for axial movement along the drive shank between a locking position, in which the collar contacts the locking element and biases the locking element radially inwardly through the channel into the aperture, and an unlocking position, in which the collar is moved out of engagement with the locking element.

19. The adapter of claim 18, wherein the collar includes a radially extending protrusion, and wherein when the locking arrangement is in the locking position, the protrusion is radially aligned with the channel, and wherein, when the locking arrangement is in the unlocking position, the protrusion is radially misaligned with the channel.

20. The adapter of claim 18, wherein the adapter includes a biasing member engaging the collar and biasing the collar toward the locking position.

21. The adapter of claim 16, wherein the tool element includes radially outwardly extending splines, and wherein complimentary splines extend radially inwardly from the second end of the drive shank into the aperture for drivingly engaging the radially outwardly extending splines of the tool element.

22. The adapter of claim 15, wherein the second power tool is a rotary hammer and the stuck tool element is a bit for use with the rotary hammer, and wherein the first power tool is an impact wrench.

23. The adapter of claim 15, wherein the first power tool is an impact wrench, and wherein the rotational motion includes rotational impacts.

24. The adapter of claim 15, wherein the first end of the adapter defines a rearward aperture, the drive member of the first power tool being matingly engageable in the rearward aperture to drivingly connect the first power tool to the adapter.

25. The adapter of claim 24, wherein the drive member of the first power tool has a substantially square cross-sectional shape, and wherein the rearward aperture in the first end of the drive shank has a complimentary square cross-sectional shape for matingly receiving the drive member.

26. The adapter of claim 24, wherein the drive member of the first power tool includes at least one substantially flat side, and wherein the first end of the drive shank includes at least one substantially flat side partially defining the rearward aperture, the at least one substantially flat side of the drive member of the first power tool being engageable with the at least one substantially flat side of the rearward aperture to drivingly connect the drive member of the first power tool to the adapter.

27. The adapter of claim 24, wherein one of the first end of the adapter and the drive member of the first power tool defines a radially extending channel, and wherein an other of the first end of the adapter and the drive member of the first power tool includes a radially extending retaining member engageable in the channel to lockingly secure the drive member of the first power tool in the rearward aperture of the adapter.

28. The adapter of claim 15, wherein the drive member of the first power tool includes a chuck, and wherein the first end of the drive shank includes an axially extending drive shaft engageable in the chuck.

29. A method of using an adapter to remove a stuck tool element from a workpiece, the adapter including a drive shank having a first end and a second end, the method comprising:
providing a first power tool having a housing, a motor supported by the housing and a drive member drivingly connected to the motor and rotatable in a first rotational direction;
connecting the tool element to the drive member of the first power tool;
rotating the tool element and the drive member of the first power tool in the first rotational direction;
driving the tool element into the workpiece with the first power tool;
catching the tool element in the workpiece so that the workpiece engages the tool element, preventing movement of the tool element with respect to the workpiece;
disconnecting the tool element from the first power tool;
providing a second power tool having a housing, a motor supported by the housing and a drive member drivingly connected to the motor and rotatable in a second rotational direction;
connecting the first end of the adapter to the drive member of the second power tool;
connecting the second end of the adapter to the tool element;
rotating the tool element, the adapter and the drive member of the second power tool in the second rotational direction to disengage the tool element from the workpiece; and
withdrawing the tool element from the workpiece.

30. The method of claim 29, wherein the first power tool is a rotary hammer and the second power tool is an impact wrench.

31. The method of claim 29, wherein the adapter includes a locking arrangement, and wherein the act of connecting the second end of the adapter to the tool element includes securing the tool element in the aperture with the locking arrangement.

32. The method of claim 29, wherein the drive member of the second power tool is rotatable in the first rotational direction, and wherein the method further comprises the act of rotating the drive member of the second power tool, the tool element and the adapter in the first rotational direction to drive the tool element into the workpiece with the second power tool.
